(19) United States
(12) Patent Application Publication
(10) Pub. No.: US 2003/0112253 A1
(43) Pub. Date: Jun. 19, 2003

(54) Method and apparatus for active graphical controls

(76) Inventors: Robert Cazier, Fort Collins, CO (US); James W. Owens, Fort Collins, CO (US)

Correspondence Address: HEWLETT-PACKARD COMPANY, Intellectual Property Administration, P.O. Box 272400, Fort Colllins, CO, 80527-2400, US

(21) Appl. No.: 10/023,608

(22) Filed: Dec. 17, 2001

(51) Int. Cl. G09G 5/00

(52) U.S. Cl. 345/619

(57) ABSTRACT

An active graphical control that automatically maintains a minimum level of contrast between the control and the background against which the control is being displayed is disclosed.

### FIELD OF THE INVENTION

This invention relates generally to graphical controls and more specifically to active graphical controls that maintain a predetermined level of contrast against a background. BACKGROUND OF THE INVENTION

Desktop computers, portable computers, PDA's, digital cameras, handheld game machines and any device that has a display that can show a background scene can have a problem when the graphical control for the user interface is close to the color of the background. For example a digital camera typically uses the onboard display to show the user the digital images recorded by the camera. The display also typically has some user interface controls shown to allow the user to navigate among the images stored in the camera. When the color in the image being displayed closely matches the color used to display the graphical control of the user interface, the graphical control may become difficult to see. Another example is the desktop of the Microsoft Windows™ operating system. When a background or pattern is displayed on the desktop that closely matches the color of one of the icons or programs on the desktop, the icon or program may become difficult to see. Therefore there is a need for a graphical control or user interface that maintains a predetermined contrast against the area where the graphical control is being displayed.

### SUMMARY OF THE INVENTION

An active graphical control that automatically maintains a minimum level of contrast between the control and the background against which the control is being displayed.

### BRIEF DESCRIPTION OF THE DRAWINGS

FIG. 1 is a drawing of a display with graphical controls that have a similar color to the background that is displayed.

FIG. 2 is a flow chart of one embodiment of the present invention.

FIG. 3 is a drawing of a close up of a segment of a graphical control.

### DETAILED DESCRIPTION OF THE PREFERRED EMBODIMENT

Some digital devices have two levels of programs running on the device and some have only one level of programs running on the device. Portable computers typically have two levels of programs running. An operating system is one level of programming and then the programs running on the operating system are the second level. An example of a program that would run on the operating system is a word processing program. Operating systems are programs that typically control, or provide an interface for, the hardware of the device. For example, operating systems typically control the allocation of memory, the access to storage, the access to the display device, and the input/output channels of the device. Digital cameras typically only have one level of program operating on the device, typically called firmware. The firmware on a digital camera typically acts like an operating system for the device. Firmware for today's digital cameras typically don't provide an environment for other programs to operate. However in the future digital cameras may include operating systems that do allow a second level of programs to operate.

A device that only has one level of programs running on it typically has total control over what is currently shown on the display. The device knows the location and color of all graphical controls and can determine the color of the pixels near or adjacent to the graphical controls. This can be done by evaluating the copy of the background displayed or by reading the display memory directly. Or there may be special hardware in the device that allows this operation to be done in hardware. For example the device may contain a graphical processor that has a background display plane and a foreground display overlay. The graphical processor may be configured to automatically maintain a predetermined level of contrast between elements in the foreground display overlay compared to the current content of the background display plane.

The operating system for a device that has more than one level of programs may show controls on the display or it may allocate portions of the display to a second level program running on top of the operating system. In this case the operating system may not directly control what is currently shown on the display. The operating system may not control what is displayed by the second level program, but the operating system can typically determine what is being displayed on the display device. The first level program (operating system) may use its own system level calls to determine the content of the display or it may use lower level commands directly. The lower level command may access the video memory or may read a copy of the files being displayed.

A second level program that is using the display may control all or a portion of the display. The second level program typically will know what is being displayed on the portions of the display device that it controls. Using common system calls the second level program can find out what is being shown on the display near or next to the area of the display that it controls. For example under the Microsoft Windows™ operating system, a program could use GetDiBits( ) to determine the current content of an area of the display. Therefore all three types of programs (firmware, operating systems, and second level programs) can determine what is currently being shown on the display.

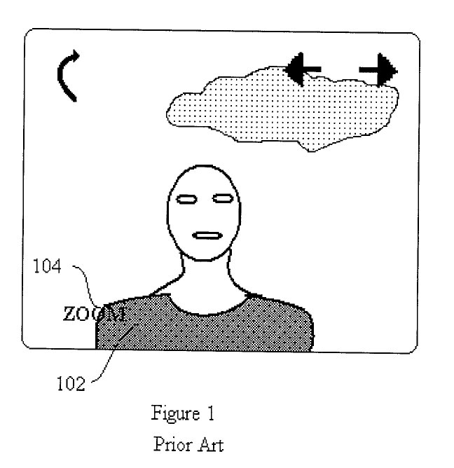

The display area of a device can be used for many purposes. Typically the display area is used to show controls for programs or controls for the user interface for the device. In many cases the program controls or user interface controls are shown on the display device against a background (see FIG. 1). A Background can be an image, a pattern, a color, a video or the like. Most operating systems allow the user to select what is displayed for the background. Some devices, for example digital cameras, display images on the device and have the graphical controls for the camera's user interface superimposed on top of the image. In this case the image is considered the background. When the background 102 is close to a color on the graphical control 104 for a program or device, the graphical control 104 may become difficult to see. A graphical control may be an icon, a bit map, text, or the like, shown on the display to enable user interaction with the program or device. For example a graphical control could be, but is not limited to, a drop down menu, a button, an arrow, crosshairs, edit boxes, icons, drawings, thumbnails, or pictures.

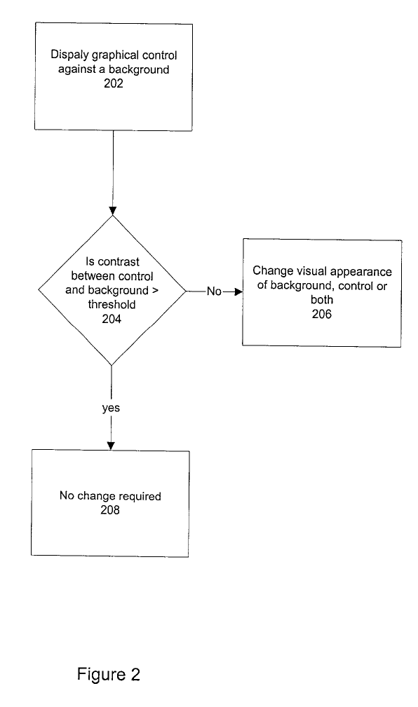

In one embodiment of the current invention a digital device would have a display on the device. The device would have the ability to show backgrounds on the display (see FIG. 2). The device would also show active graphical controls superimposed on the background 202. An active graphical control is a control that maintains a minimum level of contrast between the graphical control and the background against which the graphical control is shown. The level of contrast between the graphical control and the background is compared to a threshold 204. When the level of contrast is below the threshold the visual appearance is changed 206 by either changing the visual appearance of the graphical control or by changing the visual appearance of the background near where the graphical control is shown or by changing both the background and the graphical control. One way of changing the visual appearance is to change the color. In this application changing the color includes changing the hue, the saturation, the intensity, or a combination of the hue, saturation, and intensity.

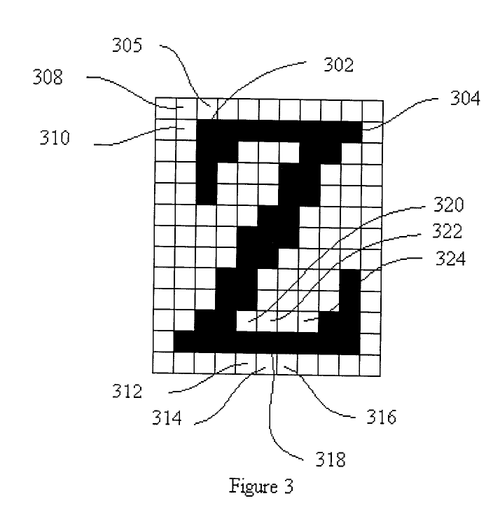

The display devices used today typically are made up from small elements called pixels. One way to measure contrast is to compare the color of a background pixel with the color of a pixel on the graphical control that is adjacent to or near the background pixel (see FIG. 3). For ease of understanding a reduced number of pixels has be depicted in FIG. 3. Some pixels on graphical controls may have more than one background pixel that is adjacent to the graphical control pixel. For example pixel 302 on graphical control 304 is adjacent to background pixels 305, 308, and 310. In one embodiment of the current invention the contrast between each background pixel that is adjacent to a graphical control pixel is calculated. In another embodiment the contrast between the average of the adjacent background pixels and the graphical control pixel is calculated. For example the average of background pixels 312, 314, and 316 would be compared to graphical control pixel 318 and a second average of background pixels 320, 322 and 324 would also be compared to graphical control pixel 318. In another embodiment the contrast between a background pixel and all graphical control pixels that are adjacent to the background pixel is calculated. In another embodiment the contrast is calculated between background pixels and graphical control pixels that have the most connecting surfaces. For example a graphical control pixel 318 with a common edge with one background pixel 314 and only a common corner with other background pixels 316 and 312 would be compared with the background pixel 314 having the common edge. Typically in today's high resolution displays graphical controls are thicker than one pixel. The outer perimeter of a graphical control is defined by the pixels around the edge of the graphical control. The contrast between background pixels and graphical control pixels does not need to be limited to pixels that are adjacent to each other. Areas or regions of the background or graphical control can also be used to calculate a contrast measure. Some graphical controls contain pixels that are considered transparent, for example icons in the Microsoft Windows ™ environment. These pixels are part of the graphical control but allow the background to show through to the user. In graphical controls that contain transparent pixels the contrast may be calculated between the background pixels showing through the transparent pixels and the non-transparent pixels in the graphical control.

A graphical control may be made from multiple elements. For example when the graphical control is text, each letter in the text string may be a graphical element. When the graphical control has multiple elements each element may be checked for proper contrast. When the contrast for a single element and that elements background falls below a threshold, the visual appearance of just that element or background may be changed or the visual appearance of all the elements may be changed.

There are many ways to measure contrast. One way is to use a measure of the smallest noticeable difference or ΔL. The ΔL can be calculated using the red, green, and blue pixel values of the background and graphical control pixels. If the difference in color between the background pixel and the graphical control pixel is smaller than a predetermined number of ΔL's then the visual appearance would be changed. ΔL calculations are well known in the arts. Another way to calculate a contrast is to compare the difference between the each color component (R, G, B) in the background to the corresponding color component in the graphical control. For example compare the difference between the red background pixel and the red graphical control pixel with a threshold level (is R1−R2<T). When all color components (R, G, and B) have a difference below the threshold, the visual appearance would be changed. Another way, similar to the ΔL calculation, is to use a predetermined color amount. Using this method the RGB components of the background pixel and the graphical control pixel would be converted into a color space and then the distance between the two pixels would be calculated. If the distance is below a predetermined amount the visual appearance would be changed. There are many different color spaces that may be used, CIE, Munsell, and LAB color spaces are a few examples.

When the contrast between the background and the graphical control has been determined to be below the desired amount the visual appearance will be changed. The visual appearance of the background, the graphical control or a combination of both can be changed. Changing the visual appearance can be done on an individual pixel level or can be done on a macro level. In the first case only the pixels that have contrast below the threshold would be changed and in the second case the visual appearance of pixels who's contrast is already above the threshold may be changed. For example given a graphical control having a color, and a background that has multiple colors, and some of the background colors causes the contrast level between the background and the graphical control to fall below the predetermined level, you have a number of choices on what to change. In one embodiment only the color of the background pixels who's contrast falls below the threshold would be changed. In another embodiment the color of the pixels in the graphical control who's contrast falls below the threshold would be changed. In another embodiment both the graphical control and the background pixels would be changed when the contrast falls below the threshold. In another embodiment the color of all the pixels in the graphical control would be changed. When all the pixels in the graphical control are changed the new color selected would be chosen such that all pixels in the graphical control would have a contrast higher than the threshold. When changing the color of a pixel the hue, saturation, intensity or a combination of any two or a combination of all three can be changed.

In a device that only has one level of program running on the device, the program would cause the change in visual appearance. In a device having more than one level of programs operating on it, the first level program may change the visual appearance or the higher level programs may change the visual appearance.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An active graphical control comprising:
at least one graphical element with at least a first pixel the pixel having a first color;
a means for detecting at least one color in a background where the at least one color is near the first pixel;
the at least one pixel configured to change to at least a second color when the contrast between the first color and the at least one color in the background is below a predetermined level.

2. The active graphical control of claim 1 where there is at least a second color in the background near the graphical element, and the at least one graphical element changes to a third color at the place where the second color is near the graphical element.

3. The active graphical control of claim 1 where the second color is user selectable.

4. The active graphical control of claim 1 where the second color is selected to maximize the contrast against the background color.

5. The active graphical control of claim 1 where there is at least a second color in the background near the first pixel, and the second color of the pixel is chosen to maintain a predetermined level of contrast between both the first color in the background and the at least second color in the background.

6. The active graphical control of claim 1 where the graphical element is text.

7. An active graphical control comprising:
a first graphical element with at least a first color and having an outer perimeter;
a means for detecting a at least one background color where the at least one background color is adjacent to the outer perimeter;
the first graphical element configured to change the at least one background color to a second background color when the contrast between the at least one background color and the first color is below a predetermined level.

8. The active graphical control of claim 7 where there is at least a third background color adjacent to the outer perimeter of the graphical element, and the at least one graphical element changes the third background color to a fourth background color at the place where the third background color is adjacent to the outer perimeter of the graphical element.

9. An active graphical control comprising:
a first graphical element with at least a first color and having at least one transparent component;
a means for detecting at least one background color where the at least one background color is underneath the transparent component;
the first graphical element configured to change the at least one background color to a different background color when the contrast between the first color and the at least one background color is below a predetermined level.

10. The active graphical control of claim 9 where there is at least a second background color underneath the transparent component, and the second background color changes to a third background color.

11. A method for displaying an active graphical control comprising:
(a) detecting at least one background color near the active graphical control;
(b) determining a contrast between the at least one background color and at least one color in the graphical control;
(c) changing the at least one color in the graphical control to at least a second color when the contrast between the first color and the at least one background color is below a predetermined level.

12. The method of claim 11 where steps (a) through (c) are repeated each time the background color changes.

13. The method of claim 11 where steps (a) through (c) are repeated each time the graphical control is moved.

14. The method of claim 11 where there is at least a second background color near the graphical control, and the second color of the graphical control is chosen to maintain a predetermined level of contrast between both the first background color and the at least second background color.

15. A method for displaying an active graphical control comprising:
(a) displaying a graphical control against a background;
(b) determining at least one contrast level between the background and the graphical control;
(c) changing the visual appearance of the graphical control when the at least one contrast level is below a predetermined amount.

16. A method for displaying an active graphical control comprising:
(a) detecting at least one background color adjacent to the active graphical control;
(b) determining a contrast between the at least one background color and at least one color in the active graphical control;
(c) changing the at least one background color adjacent to the active graphical control to a second color when the contrast between the first color and the at least one background color is below a predetermined level.

17. The method of claim 15 where steps (a) through (c) are repeated each time the background adjacent to the graphical control changes comprising.

18. A program configured to display an active graphical control comprising:
a first graphical element with at least a first color and having an outer perimeter;
at least one background color where the at least one background color is adjacent to the outer perimeter;
the first graphical element configured to change to at least a second color when the contrast between the first color and the at least one background color is below a predetermined level.

19. The program of claim 17 where there is at least a second background color adjacent to the outer perimeter of the graphical element, and the second color of the graphical element is chosen to maintain a predetermined level of contrast between both the first background color and the at least second background color.

20. A program configured to display an active graphical control comprising:
a first graphical element with at least a first color and having an outer perimeter;
at least one background color where the at least one background color is adjacent to the outer perimeter;
the first graphical element configured to change the at least one background color to a second background color when the contrast between the first color and the at least one background color is below a predetermined level.

21. A program configured to display an active graphical control comprising:
a first graphical element with at least a first color and having at least one transparent component;
at least one background color where the at least one background color is underneath the transparent component;
the first graphical element configured to change the at least one background color to a second background color when the contrast between the first color and the at least one background color is below a predetermined level.

22. A portable digital device comprising:
a display area;
a microprocessor configured to display at least one background on the display area, the micro processor also configured to display at least one graphical control on the display area over the background, the graphical control having at least one color, where at least one color of the displayed graphical control is chosen to create a predetermined level of contrast between the background and the displayed graphical control.

23. The portable digital device of claim 21 where the microprocessor is configured to change the color of the graphical control when the background changes to a color that has a level of contrast with the graphical control below a predetermined level.

24. A digital camera comprising:
a display area;
a microprocessor configured to display at least one image on the display area, the micro processor also configured to display at least one graphical control on the display area over the displayed image, where at least one color of the displayed graphical control is chosen to create a predetermined level of contrast between the images and the displayed graphical control.

25. The digital camera of claim 23 where the at least one color is selected to maximize the contrast against the image.

26. The digital camera of claim 23 where the graphical control is text.
